(19) United States
(12) Patent Application Publication
(10) Pub. No.: US 2022/0069304 A1
(43) Pub. Date: Mar. 3, 2022

(54) ANODE ACTIVE MATERIAL, PREPARATION METHOD THEREFOR, AND LITHIUM SECONDARY BATTERY COMPRISING SAME

(71) Applicant: TOKAI CARBON KOREA CO., LTD, Gyeonggi-do (KR)

(72) Inventor: Seok Min KANG, Gyeonggi-do (KR)

(73) Assignee: TOKAI CARBON KOREA CO., LTD, Gyeonggi-do (KR)

(21) Appl. No.: 17/414,128

(22) PCT Filed: Dec. 5, 2019
(86) PCT No.: PCT/KR2019/017098

§ 371 Date: Jun. 15, 2021

(30) Foreign Application Priority Data
Dec. 17, 2018 (KR) 10-2018-0163532

(51) Int. Cl. H01M 4/587; H01M 4/38; H01M 4/04; H01M 4/36

(52) U.S. Cl. CPC H01M 4/587; H01M 4/386; H01M 2004/021; H01M 4/364; H01M 4/366; H01M 4/043

(57) ABSTRACT

The present invention relates to an anode active material, a preparation method therefor, and a lithium secondary battery comprising same. An anode active material according to one aspect of the present invention comprises a carbon material and silicon particles, wherein the carbon material encompasses, inside bulk particles, the silicon particles and a method for preparing the anode active material, according to another aspect, comprises the steps of: preparing a mixture powder by mixing a carbon material and silicon particles; and mechanically over-mixing the mixture powder.

### TECHNICAL FIELD

The present disclosure relates to an anode active material (negative active material), a preparation method therefor, and a lithium secondary battery including the same.

### BACKGROUND ART

When lithium secondary batteries, which have recently been in the spotlight as a power source for portable small electronic devices, use an organic electrolyte, the batteries show a discharge voltage that is more than twice as high as that of batteries that use an aqueous alkaline solution according to the related art, and as a result, a high energy density.

As cathode active materials of the lithium secondary batteries, an oxide composed of a transition metal and lithium, which has a structure capable of intercalation of lithium ions, such as lithium cobalt oxide (LiCoO₂), lithium nickel oxide (LiNiO₂), or lithium nickel cobalt manganese oxide (Li[NiCoMn]O₂, Li[Ni_{1-x-y}CoₓM_{y}]O₂), is mainly used.

As anode active materials, various types of carbon-based materials including artificial, natural graphite, and hard carbon which are capable of intercalating/desorbing lithium have been applied. However, graphite has a small capacity per unit mass of 372 mAh/g, and thus it is difficult to increase a capacity of a lithium secondary battery.

An anode active material showing a higher capacity than graphite, for example, a material (lithium alloying material) in which silicon, tin and oxides thereof are electrochemically alloyed with lithium has a high capacity of about 1000 mAh/g or higher and a low charge/discharge potential of 0.3 V to 0.5 V, so that it is in the spotlight as an anode active material for lithium secondary batteries.

However, when these materials are electrochemically alloyed with lithium, there is a problem in that volume expands by causing a change in a crystal structure. In this case, there is a problem that during charging and discharging, electrodes manufactured by coating the powder cause a loss due to physical contact between active materials or between active material and a current collector, and thus a capacity of the lithium secondary battery is greatly reduced as charging/discharging cycles proceed.

Accordingly, there is a need to develop a high-performance anode active material capable of further improving capacity and cycle life properties.

### DISCLOSURE OF INVENTION

### Technical Goals

To solve the above-described problems, an aspect of the present disclosure is to provide an anode active material having improved capacity and cycle properties, a preparation method therefor, and a lithium secondary battery including the same.

However, aspects of the present disclosure are not limited to the one set forth herein, and other aspects not mentioned herein would be clearly understood by one of ordinary skill in the art from the following description.

### Technical Solutions

According to an aspect, there is provided an anode active material including a carbon material and silicon particles, wherein the carbon material encompasses the silicon particles in a bulk particle.

According to an example embodiment, the carbon material may include at least one of natural graphite, artificial graphite, soft carbon, hard carbon, carbon black, acetylene black, Ketjen black, carbon fiber, carbon nanotube, graphene, and expanded graphite.

According to an example embodiment, a weight ratio of the silicon particles to the carbon material may range from 2:8 to 4:6.

According to an example embodiment, a mass ratio of the carbon material to the silicon particles may be 45 to 55:55 to 45.

According to an example embodiment, the silicon particles may be in an amount of 55% by mass (mass %) or less of the anode active material.

According to an example embodiment, the anode active material may have a radius of 12 μm or lower, and the silicon particles may be in an amount of 45 mass % to 55 mass %.

According to an example embodiment, the anode active material may have a radius of 12 μm to 18 μm, the silicon particles from the surface of the anode active material to a point of 70% of the radius toward the center from the surface of the anode active material may be included in an amount of 45 mass % to 55 mass % with respect to the anode active material in the corresponding section, and the silicon particles from the center of the anode active material to a point of 30% of the radius toward the surface from the center of the anode active material may be included in an amount of 10 mass % to 45 mass % with respect to the anode active material in the corresponding section.

According to an example embodiment, the anode active material may have a radius of 18 μm to 22 μm, the silicon particles from the surface of the anode active material to a point of 50% of the radius toward the center from the surface of the anode active material may be included in an amount of 45 mass % to 55 mass % with respect to the anode active material in the corresponding section, and the silicon particles from the center of the anode active material to a point of 50% of the radius toward the surface from the center of the anode active material may be included in an amount less than 45 mass % with respect to the anode active material in the corresponding section.

According to an example embodiment, the anode active material may have a porosity of 1% to 7%.

According to an example embodiment, a pore of the anode active material may correspond to a space between the carbon material and the silicon particles.

According to an example embodiment, the silicon particles may have an average diameter of 50 nm to 120 nm.

According to an example embodiment, an outer coating layer outside the anode active material may be further included.

According to another aspect, there is provided a method for preparing an anode active material, the method including: a step of preparing a mixture powder by mixing a carbon material and silicon particles; and a step of mechanically over-mixing the mixture powder.

According to an example embodiment, the over-mixing may mix by a milling process.

According to an example embodiment, a milling speed of the milling process may range from 2000 rpm to 6000 rpm, and the milling process may be performed for 30 min to 480 min.

According to still another aspect, there is provided an anode including the anode active material of the example embodiments.

According to still another aspect, there is provided a lithium secondary battery including: the anode of the example embodiments; a cathode including a cathode active material, and a separator interposed between the anode and the cathode.

According to an example embodiment, volume expansion of the anode active material during charging and discharging may be minimized

### Effects

According to an example embodiment of the present disclosure, an anode active material in which silicon particles are uniformly distributed with a carbon material from the surface to the center point, may suppress volume expansion, compensate for an irreversible capacity loss, and improve a cycle life property.

According to an example embodiment of the present disclosure, a method for preparing the anode active material may uniformly distribute silicon particles with a carbon material from the surface of the anode active material to the center point through over-mixing, thereby forming a pore.

According to an example embodiment of the present disclosure, an anode may minimize volume expansion of the anode active material during charging and discharging, thereby enhancing mechanical properties and further improving performances of a lithium secondary battery.

According to an example embodiment of the present disclosure, a lithium secondary battery may have improved capacity and cycle properties.

### BRIEF DESCRIPTION OF DRAWINGS

FIG. 1 is a schematic diagram illustrating a structure of an anode active material according to an example embodiment of the present disclosure.

FIG. 2 is a schematic diagram illustrating a structure of a lithium secondary battery according to an embodiment.

FIG. 3 is a SEM image illustrating a particle morphology of an anode active material according to Example 1 of the present disclosure.

FIG. 4 is an enlarged image of a particle cross-section of an anode active material according to Example 1 of the present disclosure.

FIG. 5 is a SEM image illustrating pore distributions and porosities according to Examples 1 and 2 of the present disclosure (left: Example 1, right: Example 2).

FIG. 6 is an EDX result at the positions in the particle of an anode active material according to Example 1 of the present disclosure.

FIG. 7 is an EDX result at the positions in the particle of an anode active material according to Example 2 of the present disclosure.

### BEST MODE FOR CARRYING OUT THE INVENTION

Hereinafter, example embodiments of the present disclosure will be described in detail with reference to the accompanying drawings. When it is determined that detailed description related to a related known function or configuration may make the purpose of the present disclosure unnecessarily ambiguous in describing the present disclosure, the detailed description will be omitted. Also, terms used herein are defined to appropriately describe the example embodiments and thus may be changed depending on a user, the intent of an operator, or a custom of a field to which the present disclosure pertains. Accordingly, the terms must be defined based on the following overall description of this specification. Like reference numerals present in the drawings refer to the like elements throughout.

Throughout the specification, when any component is positioned “on” another component, this not only includes a case that the any component is brought into contact with the other component, but also includes a case that another component exists between two components.

It will be understood throughout the whole specification that, when one part “includes” or “comprises” one component, the part does not exclude other components but may further include the other components.

Hereinafter, an anode active material, a preparation method therefor, and a lithium secondary battery including the same according to the present disclosure will be described in more detail with reference to examples and figures. However, the present disclosure is not limited to these examples and figures.

According to an aspect, there is provided an anode active material including a carbon material and silicon particles, wherein the carbon material encompasses the silicon particles in a bulk particle.

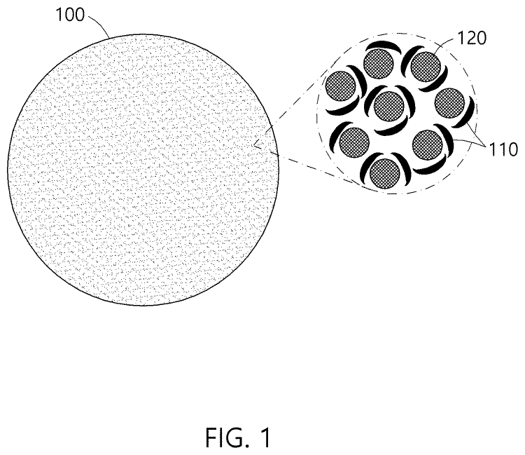

FIG. 1 is a schematic diagram illustrating a structure of an anode active material according to an example embodiment of the present disclosure. Referring to FIG. 1, when an anode active material 100 according to an example embodiment of the present disclosure is enlarged, the anode active material is in a form in which a carbon material 110 encompasses silicon particles 120 in a bulk particle. In anode active material 100 of the present disclosure, carbon material 110 and silicon particles 120 are uniformly distributed as a whole from the surface to an inside in a form in which carbon material 110 encompasses silicon particles 120.

According to an example embodiment, the carbon material 110 may include at least one of natural graphite, artificial graphite, soft carbon, hard carbon, carbon black, acetylene black, Ketjen black, carbon fiber, carbon nanotube, graphene, and expanded graphite.

According to an example embodiment, the silicon particles 120 may have an average diameter of 50 nm to 120 nm. When the average diameter of the silicon particles is lower than 50 nm, a high capacity may not be expressed, and when the average diameter of the silicon particles is higher than 120 nm, properties due to an increase in charge/discharge rate may be deteriorated.

According to an example embodiment, a weight ratio of the silicon particles to the carbon material may range from 2:8 to 4:6. When the ratio of the carbon material is too high, a rate of irreversible reaction increases during charging and discharging of lithium, and when the ratio of the carbon material is too low, an addition effect may not be displayed.

According to an example embodiment, a mass ratio of the carbon material to the silicon particles may be 45 to 55:55 to 45. Uniform dispersion of the carbon material and the silicon particles may improve expression of a battery capacity and a cycle property.

According to an example embodiment, the silicon particles may be in an amount of 55% by mass (mass %) or less of the anode active material. In the range, a rate of irreversible reaction decreases during charging and discharging of lithium, and an effect of maintaining a bond may be sufficiently obtained.

According to an example embodiment, the anode active material may have a radius of 12 μm or lower, and the silicon particles may be in an amount of 45 mass % to 55 mass %. The silicon particles may not be uniformly distributed with the carbon material from the surface of the anode active material toward the center. However, when the radius of the anode active material is 12 μm or lower, the silicon particles and the carbon material may be uniformly distributed.

According to an example embodiment, the anode active material may have a radius of 12 μm to 18 μm, the silicon particles from the surface of the anode active material to a point of 70% of the radius toward the center from the surface of the anode active material may be included in an amount of 45 mass % to 55 mass % with respect to the anode active material in the corresponding section, and the silicon particles from the center of the anode active material to a point of 30% of the radius toward the surface from the center of the anode active material may be included in an amount of 10 mass % to 45 mass % with respect to the anode active material in the corresponding section. The silicon particles may not be uniformly distributed with the carbon material from the surface of the anode active material toward the center. However, when the radius of the anode active material ranges from 12 μm to 18 μm, the silicon particles and the carbon material may be distributed uniformly to a point of 70% of the radius toward the center from the surface of the anode active material.

According to an example embodiment, the anode active material may have a radius of 18 μm to 22 μm, the silicon particles from the surface of the anode active material to a point of 50% of the radius toward the center from the surface of the anode active material may be included in an amount of 45 mass % to 55 mass % with respect to the anode active material in the corresponding section, and the silicon particles from the center of the anode active material to a point of 50% of the radius toward the surface from the center of the anode active material be included included in an amount less than 45 mass % with respect to the anode active material in the corresponding section. The silicon particles may not be uniformly distributed with the carbon material from the surface of the anode active material toward the center. However, when the radius of the anode active material ranges from 18 μm to 22 μm, the silicon particles and the carbon material may be distributed uniformly to a point of 50% of the radius toward the center from the surface of the anode active material. This means that even though the anode active material according to the present disclosure has a large bulk particle, the silicon particles and the carbon material uniformly distributed to an inside.

According to an example embodiment, when the silicon particles are distributed uniformly with the carbon materials from the surface of the anode active material to the center point, volume expansion is suppressed, and a cycle life property is improved.

According to an example embodiment, the anode active material may have a porosity of 1% to 7%. When the porosity of the anode active material is lower than 1%, a pore structure is not formed sufficiently, and thus volume expansion is not suppressed sufficiently. When the porosity of the anode active material is higher than 1%, the formation of excess pores may increase the likelihood of side reactions occurring.

According to an example embodiment, an inner porosity of the shell may be defined as follows:

Inner porosity=pore volume per unit mass/(specific volume+pore volume per unit mass)

Measurement of the inner porosity is not particularly limited, and according to an example embodiment of the present disclosure, may be performed by BELSORP (BET Equipment) manufactured by BEL JAPAN using an adsorption gas such as nitrogen.

The anode active material according to an example embodiment of the present disclosure prevents volume expansion of an electrode by acting as a buffer to mitigate volume expansion of silicon particles during charging by including pores in the range. Therefore, along with a capacity property due to the silicon particles, a cycle life property of the lithium secondary battery may be also improved by minimizing volume expansion of the anode active material during charging and discharging due to the pores. Also, since the pores may be impregnated with a non-aqueous electrolyte, lithium ions may be introduced into the anode active material, so that lithium ions may be efficiently diffused, thereby enabling high-rate charging and discharging.

According to an example embodiment, a pore of the anode active material may correspond to a space between the carbon material and the silicon. In the anode active material of the present disclosure, since the carbon material and the silicon particles are uniformly distributed as a whole, a pore corresponding to a space between the carbon material and the silicon has a very fine average particle size, and may be uniformly distributed with silicon particles as a whole. Thus, when the silicon particles are alloyed with lithium to expand a volume, it becomes possible to expand while compressing the volume of the pores, so that the appearance hardly changes.

According to an example embodiment, an outer coating layer outside the anode active material may be further included. A soft carbon-based outer coating layer may be included. For example, carbon having a softening point of about 100° C. to 340° C. may be included in an amorphous form, crystallized and partially crystallized through heat treatment to form an outer coating layer. The outer coating layer may prevent carbon-based materials from contacting an electrolyte due to SEI formation and selective permeation of Li ions.

According to another aspect, there is provided a method for preparing an anode active material, the method including: a step of preparing a mixture powder by mixing a carbon material and silicon particles; and a step of mechanically over-mixing the mixture powder.

According to an example embodiment, the step of preparing a mixture powder may prepare a mixture powder by mixing a carbon material and silicon particles.

According to an example embodiment, the over-mixing step may mechanically over-mix the mixture powder.

According to an example embodiment, the over-mixing may mix by a milling process. The milling process may include at least one of a beads mill, a high energy ball mill, a planetary mill, a stirred ball mill, a vibration mill, a SPEX mill, a planetary mill, an attrition mill, a magento-ball mill and a vibration mill. As the beads mill and ball mill, chemically inactive materials, which are not reacted with silicone and organic substances may be used, and for example zirconia materials may be used. For example, a size of the beads mill or ball mill may range from 0.1 mm to 1 mm, but not limited thereto.

According to an example embodiment, the milling process may be performed by mixing the mixture powder with an organic solvent together. As the organic solvent, a solvent having low volatility is appropriate, and an organic solvent having a flash point of 15° C. or higher may be used. For example, the organic solvent may include alcohol or alkane, and C1 to C12 alcohol or C6 to C8 alkane is preferred. For example, the organic solvent may include at least one of ethanol, isopropanol, butanol, octanol and heptane, but not limited thereto.

According to an example embodiment, the milling process time may be performed for an appropriate time in consideration of a size of an anode active material to be used, a size of a final particle to be obtained, and a size of a bead mill or ball mill to be used in a milling process.

According to an example embodiment, a milling speed of the milling process may range from 2000 rpm to 6000 rpm, the milling process may be performed for 30 min to 480 min. When the milling process rate and time are included in the range, the silicon particles are nanonized to an appropriate average particle size of 50 nm to 120 nm, and may form a van der Waals bond with a carbon material well.

According to an example embodiment, the resultant product pulverized by the milling process may evaporate an organic solvent through a drying process. Drying may be performed in a temperature range at which the organic solvent may be evaporated or volatilized, and for example, may be performed at 60° C. to 150° C.

According to an example embodiment, in the mixture, pulverized and dried by the milling process as described above, the silicon particles and the carbon material are nanonized so that the nanonized carbon material and the silicon particles are uniformly distributed therebetween.

By the method for preparing an anode active material according to the present disclosure, silicon particles are uniformly dispersed from the surface of the anode active material to the center and pores are formed, so that an anode active material having a high capacity and an excellent cycle property may be prepared.

According to still another aspect, there is provided an anode including the anode active material of the example embodiments.

Hereinafter, the anode including the anode active material will be described together while describing a lithium secondary battery.

According to still another aspect, there is provided a lithium secondary battery including: the anode of the example embodiments; a cathode including a cathode active material, and a separator interposed between the anode and the cathode.

In the lithium secondary battery according to the present disclosure, silicon particles are uniformly dispersed from the surface of the anode active material to an inside, and the silicon particles and the carbon material form pores, so that volume expansion of the anode active material may be minimized during charging and discharging. This means that the pores prevent volume expansion of an electrode by acting as a buffer to mitigate volume expansion of silicon during charging.

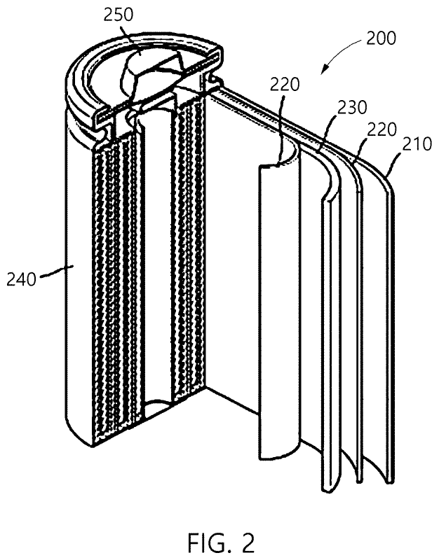

Hereinafter, the lithium secondary battery will be described with reference to FIG. 2. FIG. 2 is a schematic diagram illustrating a structure of a lithium secondary battery according to an embodiment.

As illustrated in FIG. 2, a lithium secondary battery 200 includes an anode 210, a separator 220, and a cathode 230. Anode 210, separator 220, and cathode 230 of the aforementioned lithium secondary battery are wound or folded to be accommodated in a battery container 240. Then, the battery container 240 is charged with organic electrolyte, and sealed with a sealing member 250 to manufacture the lithium secondary battery 200. The battery container 240 may have a cylindrical type, a square type, or a thin film type. For example, the lithium secondary battery may be a large thin film type battery. For example, the lithium secondary battery may be a lithium-ion secondary battery. Meanwhile, a separator may be disposed between a cathode and an anode to form a battery structure. The battery structure is stacked in a bi-cell structure and is impregnated with an organic electrolyte, so that the resulting product is accommodated in a pouch and sealed to manufacture a lithium-ion polymer secondary battery. A plurality of the battery structures is stacked to form a battery pack, and such a battery pack may be used in all devices requiring a high capacity and a high output. For example, it may be used for laptop computers, smartphones, power tools, electric vehicles, and the like.

According to an example embodiment, anode 210 may be prepared as follows. The anode may be prepared in the same manner as the cathode, except an anode active material is used instead of the cathode active material. Also, a conductive agent, a binder, and a solvent in an anode slurry composition may be the same as those mentioned in the case of the cathode.

According to an example embodiment, for example, an anode active material, a binder and a solvent, optionally a conductive agent are mixed to prepare an anode slurry composition, the anode slurry composition may be directly coated on an anode current collector to prepare an anode plate. Alternatively, the anode slurry composition may be cast on a separate support, an anode active material film peeled from the support may be laminated on an anode current collector to prepare an anode plate.

According to an example embodiment, as an anode active material, the anode active material of the present disclosure may be used. Also, the anode active material may include all anode active materials that may be used as anode active materials for lithium secondary batteries in the relevant technical field in addition to the above-described electrode active material. For example, the anode active material may include at least one of a lithium metal, a metal alloyable with lithium, a transition metal oxide, a non-transition metal oxide, and a carbon-based material.

According to an example embodiment, for example, the metal alloyable with lithium may be Si, Sn, Al, Ge, Pb, Bi, Sb, or Si—Y′ alloy (the Y′ is an alkali metal, an alkaline earth metal, a group 13 element, a group 14 element, a transition metal, a rare earth element, or a combination element thereof, but not Si), Sn—Y′ alloy (the Y′ is an alkali metal, an alkaline earth metal, a group 13 element, a group 14 element, a transition metal, a rare earth element, or a combination element thereof, but not Sn). The element Y′ may include at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te and Po.

According to an example embodiment, for example, the transition metal oxide may be lithium titanium oxide, vanadium oxide, lithium vanadium oxide, or the like.

According to an example embodiment, for example, the non-transition metal oxide may be SnO₂, SiOₓ (0<x<2) or the like.

According to an example embodiment, the carbon-based materials may be crystalline carbon, amorphous carbon, or mixtures thereof. The crystalline carbon may be graphite such as amorphous, plate-shaped, flake, spherical or fibrous natural graphite or artificial graphite. The amorphous carbon may include at least any one of soft carbon, hard carbon, mesophase pitch carbide, and fired coke.

According to an example embodiment, contents of the anode active material, the conductive agent, the binder, and the solvent are levels commonly used in lithium secondary batteries.

According to an example embodiment, the anode current collector is generally prepared in a thickness of 3 μm to 500 μm. The anode current collector is not particularly limited as long as it has conductivity without causing chemical changes to the battery, and examples of the anode current collector to be used may include copper, stainless steel, aluminum, nickel, titanium, calcined carbon; surface-treated copper or stainless steel with carbon, nickel, titanium, silver, or the like; aluminum-cadmium alloy, or the like. In addition, the anode current collector may improve a bonding strength of the anode active material by forming fine irregularities on the surface, and may be used in various forms such as films, sheets, foils, nets, porous bodies, foams, and nonwoven fabrics.

According to an example embodiment, in cathode 230, a cathode active material, a conductive agent, a binder, and a solvent are mixed to prepare a cathode slurry composition. The cathode slurry composition may be directly coated on a cathode current collector and dried to prepare a cathode plate in which a cathode active material layer is formed. Alternatively, the cathode slurry composition may be cast on a separate support, a film peeled from the support may be laminated on a cathode current collector to prepare a cathode plate in which a cathode active material layer is formed.

According to an example embodiment, a lithium-containing metal oxide is a material that may be used for the cathode active materials, and may be used without limitation, as long as it is commonly used in the relevant field. For example, a lithium-containing metal oxide to be used includes one or more of composite oxides of lithium and a metal selected from cobalt, manganese, nickel, and combinations thereof, and specifically includes a compound represented by any one of LiₐA_{1-b}B′_{b}D′₂ (in the formula, 0.90≤a≤1, and 0≤b≤0.5); LiₐE_{1-b}B′_{b}O_{2-c}D′_{c} (in the formula, 0.90≤a≤1, 0≤b≤0.5, 0≤c≤0.05); LiE_{2-b}B′_{b}O_{4-c}D′_{c} (in the formula, 0≤b≤0.5, 0≤c≤0.05); LiₐNi_{1-b-c}Co_{b}B′_{c}D′_{α} (in the formula, 0.90≤a≤1, 0≤b≤0.5, 0≤c≤0.05, 0<α≤2); LiₐNi_{1-b-c}Co_{b}B′_{c}O_{2-α}F′_{α} (in the formula, 0.90≤a≤1, 0≤b≤0.5, 0≤c≤0.05, 0<α<2); LiₐNi_{1-b-c}Co_{b}B′_{c}O_{2-α}F′₂ (in the formula, 0.90≤a≤1, 0≤b≤0.5, 0≤c≤0.05, 0<α≤2); LiₐNi_{1-b-c}Mn_{b}B′_{c}D_{α} (in the formula, 0.90≤a≤1, 0≤b≤0.5, 0≤c≤0.05, 0<α≤2); LiₐNi_{1-b-c}Mn_{b}B′_{c}O_{2-α}F′_{α} (in the formula, 0.90≤a≤1, 0≤b≤0.5, 0≤c≤0.05, 0<α<2); LiₐNi_{1-b-c}Mn_{b}B′_{c}O_{2-α}F′₂ (in the formula, 0.90≤a≤1, 0≤b≤0.5, 0≤c≤0.05, 0<α<2); LiₐNi_{b}E_{c}G_{d}O₂ (in the formula, 0.90≤a≤1, 0≤b≤0.9, 0≤c≤0.5, 0.001≤d≤0.1); LiₐNi_{b}Co_{c}Mn_{d}GₑO₂ (in the formula, 0.90≤a≤1, 0≤b≤0.9, 0≤c≤0.5, 0≤d≤0.5, 0.001≤e≤0.1); LiₐNiG_{b}O₂ (in the formula, 0.90≤a≤1, 0.001≤b≤0.1); LiₐCoG_{b}O₂ (in the formula, 0.90≤a≤1, 0.001≤b≤0.1); LiₐMnG_{b}O₂ (in the formula, 0.90≤a≤1, 0.001≤b≤0.1); LiₐMn₂G_{b}O₄ (in the formula, 0.90≤a≤1, 0.001≤b≤0.1); QO₂; QS₂; LiQS₂; V₂O₅; LiV₂O₅; LiNiVO₄; Li_{(3-f)}J₂(PO₄)₃ (0≤f≤2); Li_{(3-f)}Fe₂(PO₄)₃ (0≤f≤2); and LiFePO₄.

According to an example embodiment, in the formulas, A is Ni, Co, Mn, or a combination thereof; B′ is Al, Ni, Co, Mn, Cr, Fe, Mg, Sr, V, rare earth elements or a combination thereof; D′ is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; J is V, Cr, Mn, Co, Ni, Cu, or a combination thereof.

According to an example embodiment, a compound having a coating layer on the surface of the aforementioned compound may be used, or a mixture of the aforementioned compound and a compound having a coating layer may be used. The coating layer may include a compound of a coating element such as oxide or hydroxide of a coating element, oxyhydroxide of a coating element, oxycarbonate of a coating element, or hydroxycarbonate of a coating element. The compound forming these coating layers may be amorphous or crystalline. As a coating element included in the coating layer, Mg, Al, Co, K, Na, Ca, Si, Ti, V, Sn, Ge, Ga, B, As, Zr, or a mixture thereof may be used. A coating layer formation process may use any coating method as long as the compound may be coated by a method (e.g., spray coating, dipping method, or the like) that does not adversely affect the physical properties of the cathode active material by using these elements.

According to an example embodiment, examples of the conductive agent to be used include carbon black, graphite fine particles, natural graphite, artificial graphite, acetylene black, Ketjen black; carbon fiber; carbon nanotubes; powders, fibers or tubes of metals such as copper, nickel, aluminum and silver; conductive polymers such as polyphenylene derivatives, but are not limited thereto, and any material that may be used as a conductive agent in the related art may be used.

According to an example embodiment, examples of the binder to be used include vinylidene fluoride/hexafluoropropylene copolymer, polyvinylidene fluoride, polyacrylonitrile, polymethyl methacrylate, polytetrafluoroethylene (PTFE), a mixture of the aforementioned polymers, or styrene butadiene rubber-based polymer, or the like, and examples of the solvent to be used include N-methylpyrrolidone (NMP), acetone, or water, but are not necessarily limited thereto, and any one that may be used in the related art may be used.

According to an example embodiment, in some cases, pores may be formed inside the electrode plate by further adding a plasticizer to the cathode slurry composition.

According to an example embodiment, contents of the cathode active material, the conductive agent, the binder, and the solvent are levels commonly used in lithium secondary batteries. One or more of the conductive agent, the binder, and the solvent may be omitted depending on the use and configuration of lithium secondary batteries.

According to an example embodiment, a cathode current collector is generally prepared in a thickness of 3 μm to 500 μm. The cathode current collector is not particularly limited as long as it has conductivity without causing chemical changes to the battery, and examples of the cathode current collector to be used may include copper, stainless steel, aluminum, nickel, titanium, calcined carbon; surface-treated copper or stainless steel with carbon, nickel, titanium, silver, or the like; aluminum-cadmium alloy, or the like. In addition, the anode current collector may improve a bonding strength of the cathode active material by forming fine irregularities on the surface, and may be used in various forms such as films, sheets, foils, nets, porous bodies, foams, and nonwoven fabrics. The mixture density of the cathode may be at least 2.0 g/cc.

According to an example embodiment, the anode 210 and cathode 230 may be separated by a separator 220, and as the separator 220, any one commonly used in lithium secondary batteries may be used. Particularly, a separator which has low resistance to ion migration in the electrolyte and excellent electrolyte-soaking ability is suitable. For example, the separator may be a material selected from glass fiber, polyester, Teflon, polyethylene, polypropylene, polytetrafluoroethylene (PTFE), and combinations thereof, and may be in the form of a non-woven fabric or a woven fabric. The separator has a pore diameter of 0.01 μm to 10 μm and generally has a thickness of 5 μm to 300 μm.

According to an example embodiment, a lithium salt-containing non-aqueous electrolyte is composed of a non-aqueous electrolyte solution and lithium. Examples of a non-aqueous electrolyte to be used include a non-aqueous electrolyte solution, an organic solid electrolyte, or an inorganic solid electrolyte.

According to an example embodiment, examples of the non-aqueous electrolyte solution include aprotic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphate triester, trimethoxymethane, dioxolane derivatives, sulfolane, methyl sulfolane, 1,3-dimethyl-2-imidazolidinone, propylene carbonate derivatives, tetrahydrofuran derivatives, ethers, methyl pyropionate, or ethyl propionate.

According to an example embodiment, examples of the organic solid electrolyte include polyethylene derivatives, polyethylene oxide derivatives, polypropylene oxide derivatives, phosphate ester polymers, poly agitation lysine, polyester sulfide, polyvinyl alcohol, polyvinylidene fluoride, or a polymer containing an ionic dissociation group, or the like.

According to an example embodiment, examples of the inorganic solid electrode include nitrides, halides or sulfates of lithium, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂.

According to an example embodiment, any of the lithium salts may be used as long as they are commonly used in lithium secondary batteries, and examples of materials that are readily soluble in the non-aqueous electrolyte include at least one of LiCl, LiBr, LiI, LiClO₄ LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carboxylate, lithium tetraphenylborate, and imide.

According to an example embodiment, lithium secondary batteries may be classified into lithium-ion secondary batteries, lithium-ion polymer secondary batteries, and lithium polymer secondary batteries depending on the type of separator and electrolyte used; may be classified into cylindrical-type, square-type, coin-type, pouch-type, or the like depending on their shape; and may be classified into a bulk type and a thin film type depending on the size.

According to an example embodiment, the preparation method of these batteries is widely known in this field, so a detailed description thereof will be omitted.

According to an example embodiment, the lithium secondary battery may be used in an electric vehicle (EV) because it has excellent storage stability, lifetime, and high-rate properties at high temperatures. For example, it may be used in hybrid vehicles such as plug-in hybrid electric vehicles (PHEVs).

According to an example embodiment, in the exemplary lithium secondary battery, the electrode active material described above is used as an anode active material, but in the lithium sulfur secondary battery, the electrode active material described above may be used as a cathode active material.

Hereinafter, the present disclosure will be described in detail with reference to examples and comparative examples.

However, the following examples are merely illustrative of the present disclosure, and the present disclosure is not limited to these examples.

### EXAMPLE 1

Graphite (manufactured by Tokai Carbon, BTR, or the like) was mixed with Si nanoparticles at a ratio of 7:3 after mechanical pulverization. The mixture was mixed at 2000 rpm to 6000 rpm for 30 min to 480 min using a mixer (NOB, Mechano Fusion) manufactured by Hosokawa Micron, to prepare an anode active material of about 10 μm based on D50, and an outer coating layer was formed using soft carbon.

### EXAMPLE 2

An anode active material was prepared in the same manner as in Example 1, except the particle size was changed to 20 μm in Example 1.

### SEM Analysis—Electrode Active Material Particle Morphology

SEM analysis was performed on the anode active materials according to Examples 1 and 2. For SEM analysis, JSM-7600F manufactured by JEOL was used. A particle morphology and a particle cross section of the anode active material were analyzed.

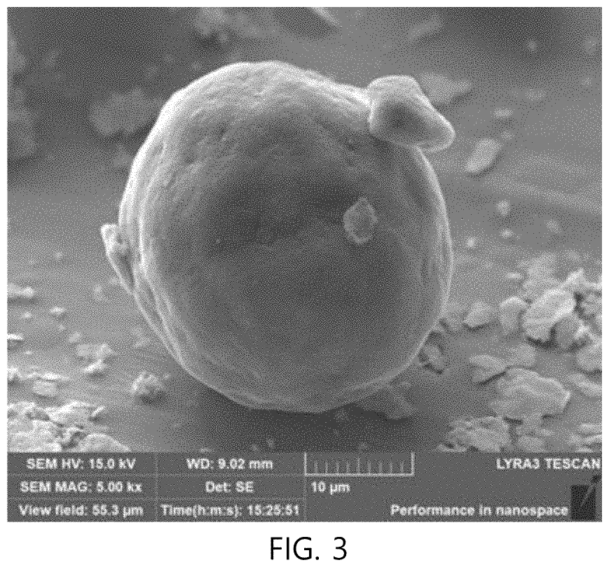

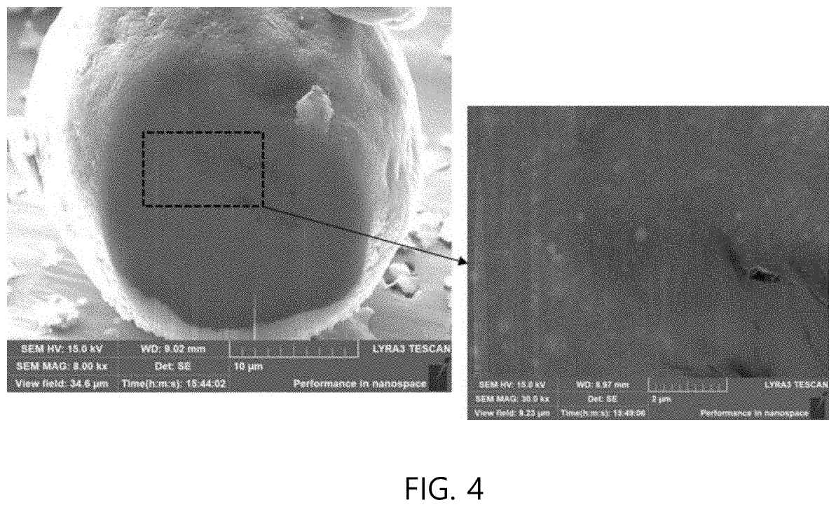

FIG. 3 is a SEM image illustrating a particle morphology of an anode active material according to Example 1 of the present disclosure, and FIG. 4 is an enlarged image of a particle cross-section of an anode active material according to Example 1 of the present disclosure. Referring to FIGS. 3 and 4, it may be seen that graphite and silicon particles are uniformly distributed to an inside of the anode active material according to Example 1, and fine pores are distributed between the adjacent graphite and silicon particles. The white part shows a silicon particle and the black part shows graphite.

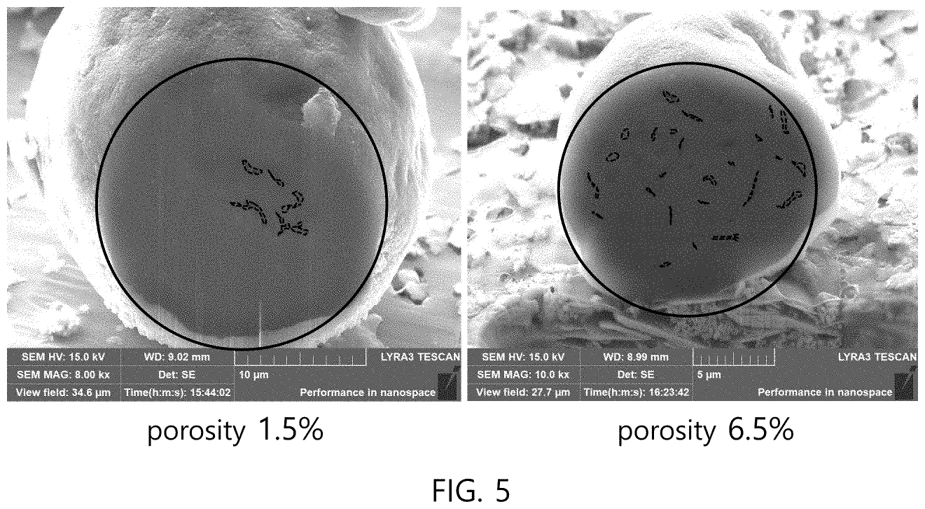

FIG. 5 is a SEM image illustrating pore distributions and porosities according to Examples 1 and 2 of the present disclosure (left: Example 1, right: Example 2). Referring to FIG. 5, it may be seen that porosity of Examples 1 and 2 is 1.5% and 6.5%, respectively. It may be seen that Example 2 has a more uniform pore distribution than Example 1.

### EDX Analysis—Electrode Active Material Graphite and Silicon Particle Distribution Analysis

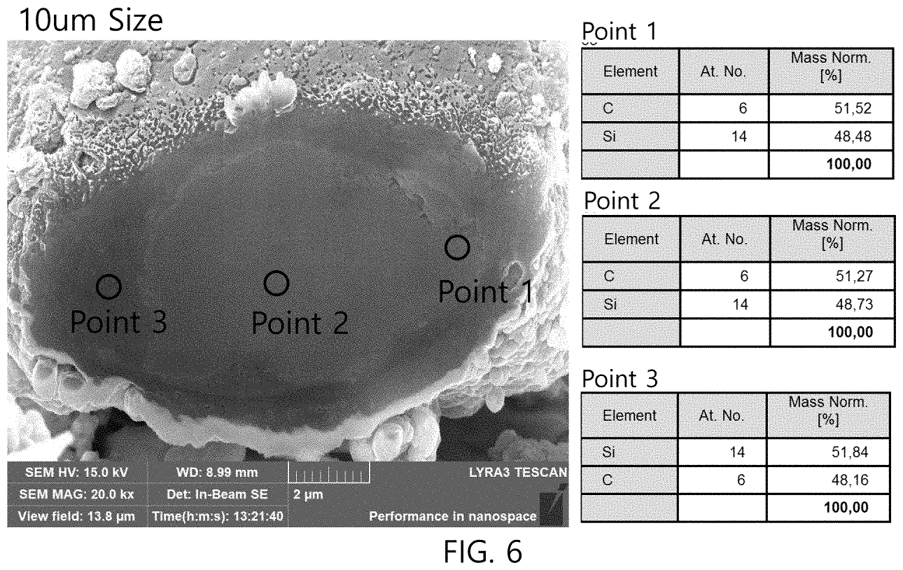

FIG. 6 is an EDX result at the positions in the particle of an anode active material according to Example 1 of the present disclosure. Referring to FIG. 6, it may be seen that a result of measuring the anode active material according to Example 1 by EDX shows a Si content of 51.52 mass % and a C content of 48.48 mass % at point 1; a Si content of 51.27 mass % and a C content of 48.73 mass % at point 2; and a Si content of 51.84 mass % and a C content of 48.16 mass % at point 3. It may be seen that graphite and silicon particles are uniformly distributed from the outside to the side of the anode active material.

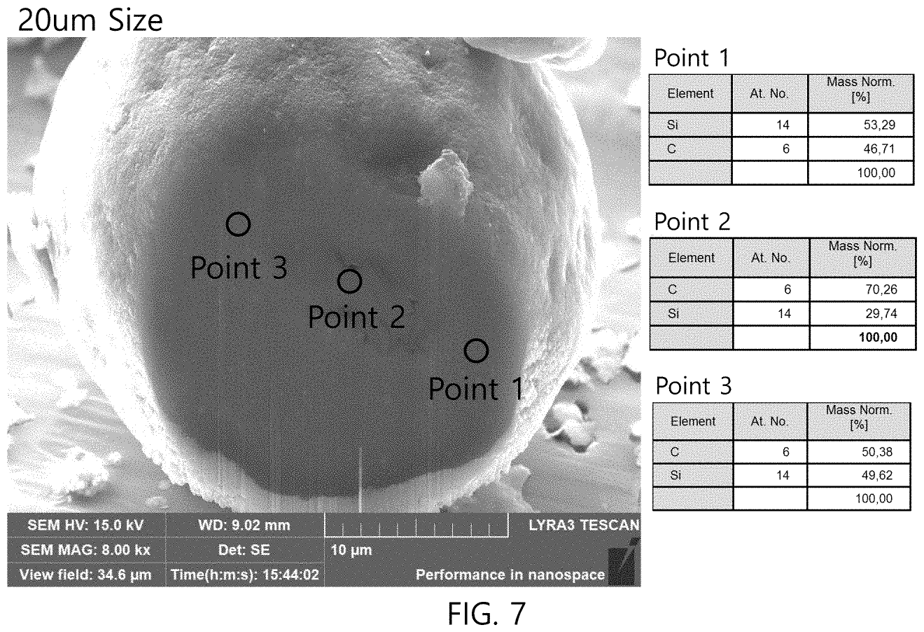

FIG. 7 is an EDX result at the positions in the particle of an anode active material according to Example 2 of the present disclosure. Referring to FIG. 7, it may be seen that a result of measuring the anode active material according to Example 2 by EDX shows a Si content of 53.29 mass % and a C content of 46.71 mass % at point 1; a Si content of 70.26 mass % and a C content of 29.74 mass % at point 2; and a Si content of 51.38 mass % and a C contents of 48.62 mass % at point 3. It may be seen that when the particle size of the anode active material increases, the silicon particles do not penetrate deeper toward the inside of the anode active material particle, but graphite and silicon particles are uniformly distributed outside.

While this disclosure includes specific example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example embodiment are to be considered as being applicable to similar features or aspects in other example embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is not limited by the detailed description, but further supported by the claims and their equivalents, and all variations within the scope of the claims and their equivalents are to be construed as being included in the disclosure.

1. An anode active material comprising a carbon material and silicon particles,
wherein the carbon material encompasses the silicon particles in a bulk particle.

2. The anode active material of claim 1, wherein the carbon material comprises at least one selected from a group consisting of natural graphite, artificial graphite, soft carbon, hard carbon, carbon black, acetylene black, Ketjen black, carbon fiber, carbon nanotube, graphene, and expanded graphite.

3. The anode active material of claim 1, wherein a weight ratio of the silicon particles to the carbon material ranges from 2:8 to 4:6.

4. The anode active material of claim 1, wherein a mass ratio of the carbon material to the silicon particles is 45 to 55:55 to 45.

5. The anode active material of claim 1, wherein the silicon particles are in an amount of 55% by mass (mass %) or less of the anode active material.

6. The anode active material of claim 1, wherein
the anode active material has a radius of 12 μm or lower, and
the silicon particles are in an amount of 45 mass % to 55 mass %.

7. The anode active material of claim 1, wherein
the anode active material has a radius of 12 μm to 18 μm,
the silicon particles from the surface of the anode active material to a point of 70% of the radius toward the center from the surface of the anode active material are included in an amount of 45 mass % to 55 mass % with respect to the anode active material in the corresponding section, and
the silicon particles from the center of the anode active material to a point of 30% of the radius toward the surface from the center of the anode active material are included in an amount of 10 mass % to 45 mass % with respect to the anode active material in the corresponding section.

8. The anode active material of claim 1, wherein
the anode active material has a radius of 18 μm to 22 μm,
the silicon particles from the surface of the anode active material to a point of 50% of the radius toward the center from the surface of the anode active material are included in an amount of 45 mass % to 55 mass % with respect to the anode active material in the corresponding section, and
the silicon particles from the center of the anode active material to a point of 50% of the radius toward the surface from the center of the anode active material are included in an amount less than 45 mass % with respect to the anode active material in the corresponding section.

9. The anode active material of claim 1, wherein the anode active material has a porosity of 1% to 7%.

10. The anode active material of claim 9, wherein a pore of the anode active material corresponds to a space between the carbon material and the silicon particles.

11. The anode active material of claim 1, wherein the silicon particles have an average diameter of 50 nm to 120 nm.

12. The anode active material of claim 1, further comprising:
an outer coating layer outside the anode active material.

13. A method for preparing an anode active material, the method comprising:
preparing a mixture powder by mixing a carbon material and silicon particles; and
mechanically over-mixing the mixture powder.

14. The method of claim 13, wherein the over-mixing mixes by a milling process.

15. The method of claim 14, wherein
a milling speed of the milling process ranges from 2000 rpm to 6000 rpm, and
the milling process is performed for 30 min to 480 min.

16. The anode active material of claim 1, wherein an anode comprises the anode active material.

17. A lithium secondary battery comprising:
the anode of claim 16;
a cathode comprising a cathode active material; and
a separator interposed between the anode and the cathode.
